(19) United States
(12) Patent Application Publication
(10) Pub. No.: US 2025/0268231 A1
(43) Pub. Date: Aug. 28, 2025

(54) SYSTEM AND METHOD FOR MONITORING AND CONTROLLING PET ACTIVITY

(71) Applicant: Sinan Kaya, North Balgowlah (AU)

(72) Inventor: Sinan Kaya, North Balgowlah (AU)

(73) Assignee: Ashop Commerce Pty Ltd., North Balgowlah (AU)

(21) Appl. No.: 18/588,088

(22) Filed: Feb. 27, 2024

(51) Int. Cl. A01K 15/02; A01K 27/00; A01K 29/00; G06V 40/10

(52) U.S. Cl. CPC A01K 15/021; A01K 27/001; A01K 27/009; A01K 29/005; G06V 40/10

(57) ABSTRACT

An artificial intelligence based system and method for monitoring and controlling pet activity is disclosed. The system comprises a pet control device associated with a pet, a user device associated with a user, smart cameras disposed at designated areas, and a computing device in communication with the user device, the smart camera and the pet control device. The smart camera and computing device are provided as a single unit. The smart camera detects the presence of pet in a designated zone and captures visual data of the pet. The computing device enables the user to define designated zone and at least one restricted action for corresponding designated zone for monitoring activity of the pet at the designated zone. The computing device detects the presence of pet in the designated zone, detects performance of restricted action at the designated zone and provides alert to the user and the pet.

### TECHNICAL FIELD

The present invention generally relates to pet management. More specifically, the present invention relates to an artificial intelligence based system and method for monitoring and controlling pet activity.

### BACKGROUND

Pets are often left alone especially when owners are away for work or other commitments. During these periods of absence, pets can find themselves in situations that demand their owner's attention. For instance, they may enter restricted areas, such as bedrooms, gardens, or other restricted zones, where the pets may engage in behaviors like scratching furniture, tearing apart pillows, destroying the plants, or other restricted actions like urinating, or defecating.

Pet performing restricted actions can result in a range of negative consequences, including safety risks, property damage, ineffective training, etc. Consistent and timely alerts play a crucial role in promoting responsible pet ownership, ensuring pet safety, and maintaining a harmonious environment within the household.

Further, a few patent references related to monitoring pet activity are discussed as follows. U.S. Pat. No. 9,642,340 of Allen L. Brown et al. entitled “remote pet monitoring systems and methods” discloses a system comprising a base station, a first monitoring device, and a second monitoring device. The base station and first monitoring device are configured to capture a first data relating to a first monitored area and transmit the first data to the base station. The second monitoring device is configured to capture second data relating to a second monitored area and transmit the second data to the base station. The first monitored area and the second monitored area are adjacent to one another. The base station is configured to determine a location of the pet as being in the first monitored area or the second monitored area. The base station is configured to determine a status of the pet based on at least one of the first and second data.

U.S. Pat. No. 11,166,435 of Terry Anderton et al. entitled “Methods and systems for deterring animals to approach or enter identified zones” discloses an animal restricted zone system comprising a smart collar and a plurality of powered transceivers. Each of the plurality of powered transceivers has a unique identification and is configured to emit a signal. The smart collar is configured to read and record the signal strength of each of the transmitters at various locations and use that information to create prohibited zones that could be downloaded onto the smart collar. The smart collar is configured to determine whether or not the smart collar has entered the desired prohibited zone using the stored table. The smart collar also contains a stimulus emitter for providing a warning to the animal and a communication device configured to alert the owner.

However, the existing references primarily focus on monitoring the pet's location and preventing the pets from entering restricted zones and lack to provide an effective solution for detecting the restricted actions being performed at one or more zones and preventing the pets from performing the restricted actions.

Therefore, there is a need for a system and method for monitoring and controlling pet activity. Further, the system needs to detect the presence of pet in certain areas, detect restricted actions being performed by the pet at certain areas and provide alerts to prevent the pet from performing the restricted action.

### SUMMARY

The present invention discloses an artificial intelligence based system and method for monitoring and controlling pet activity. The system comprises a pet control device associated with the pet, a user device associated with a user, and at least one smart camera disposed at one or more designated areas incorporated with a computing device. The computing device is in communication with the user device, the smart camera and the pet control device via a network.

The smart camera is configured to detect the presence of pet in a designated zone and capture visual data of pet at the designated zone. In another embodiment, the smart camera comprises a power source to supply power to the smart camera. The power source comprises a battery, a solar panel module and a power interface to directly connect to an external power source.

The pet control device comprises a control module and a communication module in communication with the control module. The pet control device is configured to wirelessly communicate with the smart camera and the computing device via the communication module. The pet control device further comprises a power source module to supply power to the pet control device. In one embodiment, the power source module comprises a battery to supply power to the pet control device. The power source module further comprises a solar panel module and a power interface to directly connect to an external power source. The pet control device further comprises at least one of an audio sensor and a video sensor. In one embodiment, the pet control device is configured as a collar. In another embodiment, the pet control device is configured as an anklet.

The computing device comprises a computer vision module and an artificial intelligence module. The computing device is configured to enable the user to define at least one designated zone using the user device for monitoring the activity of the pet at the designated zone. The computing device provides an interface with at least six movable corners to define the designated zone. The computing device is further configured to enable the user to define at least one restricted action for the corresponding designated zone. In an example, the restricted action includes entry into one or more designated zones, sitting at one or more designated zones, sleeping at one or more designated zones and defecating at one or more designated zones.

The computing device is further configured to receive visual data of the pet from the smart camera. The computing device is further configured to detect the presence of pet in the designated zone and performance of restricted action at the designated zone. Further, the computing device is configured to provide one or more first alerts to the pet to inhibit the pet from performing the restricted action via the pet device. The computing device is further configured to provide one or more second alerts to the user regarding the restricted action being performed by the pet at the designated zone via the user device. The computing device is further configured to provide second alert on disconnection of the pet control device and the smart camera. The first alert includes audio alert and vibration alert. The first alert further includes ultrasonic sound and vibration alert.

Further, the computing device enables the user to adjust an intensity of the first alert and the second alert via the user device. The computing device enables the user to define a type of first alert and second alert via the user device.

The computing device is further configured to provide notifications regarding the restricted actions of the pet and a power level of the pet control device via the user device.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 exemplarily illustrates an environment of an artificial intelligence based system for monitoring and controlling pet activity, according to an embodiment of the present invention.

FIG. 2 exemplarily illustrates an environment including a pet control device and a camera connected to the network, according to an embodiment of the present invention.

FIG. 3 exemplarily illustrates a flowchart of a method for monitoring and controlling pet activity, according to an embodiment of the present invention.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

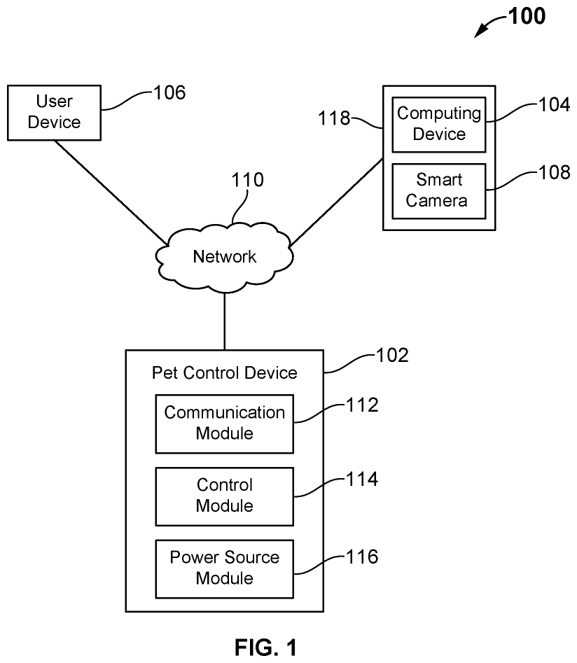

FIG. 1 exemplarily illustrates an environment 100 of a system for monitoring and controlling pet activity, according to an embodiment of the present invention. The system comprises a computing device 104, a pet control device 102, a user device 106 and one or more smart cameras 108. In one embodiment, the computing device 104 and the smart camera 108 is configured as a single unit 118. The computing device 104 is in communication with the pet control device 102, the user device 106 and the smart camera 108 via a network 110.

The pet control device 102 is associated with the pet. The pet is a trained pet. The pet includes, but not limited to, a dog and cat. The pet control device 102 comprises a control module 114, a communication module 112 connected to the control module 114 and a power source module 116 connected to the control module 114 and the communication module 112. The pet control device 102 is configured to communicate with the computing device 104 and the smart camera 108 via the communication module 112. In one embodiment, the pet control device 102 communicates with the smart camera 108 through Bluetooth protocol. In one embodiment, the pet control device 102 is configured as a collar. In another embodiment, the pet control device 102 is configured as an anklet. In one embodiment, the power source module 116 comprises a battery, a solar panel module and a power interface to directly connect to an external power source or alternating current (AC) power source. In one embodiment, the battery comprises a rechargeable battery. The pet control device 102 comprises at least one of an audio sensor and a video sensor.

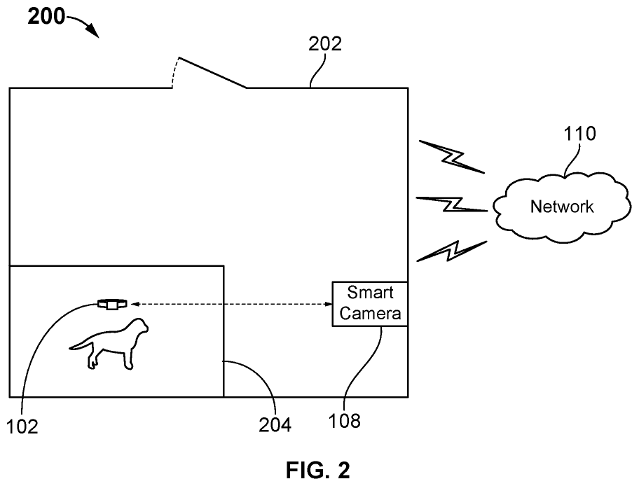

In one embodiment, one or more smart cameras 108 are disposed at one or more designated areas. The smart camera 108 is configured to detect the presence of pet in a designated zone 204 (shown in FIG. 2) of the designated area and capture visual data of pet at the designated zone 204. The smart camera 108 is configured to store the visual data. In one embodiment, the smart camera 108 comprises a computer vision module and an artificial intelligence module. In one embodiment, the smart camera 108 comprises a power source. In one embodiment, the power source comprises a solar panel module to supply power to the smart camera 108. The power source further comprises a battery and a power interface. The power interface is configured to directly connect the smart cameras to power source or alternating current (AC) power source. In one embodiment, the battery comprises a rechargeable battery. In one embodiment, smart camera 108 comprises a port, for example, an USB-C port, to supply power from an external power source. The port further enables to recharge the power source of the smart camera 108. In one embodiment, the power source comprises one or more batteries. The smart cameras 108 could be used in both indoor environment and outdoor environment.

The user device 106 is associated with a user. The user could be a person related to the pet. The user device 106 is configured to provide an interface to access the services provided by the computing device 104. The interface, for example, an application that allows the user device 106 to wirelessly connect and access the computing device 104 via the network 110. The user device 106 includes, but not limited to, a desktop computer, a laptop computer, a mobile phone, a personal digital assistant, and the like. The user device 106 is configured to execute one or more client applications such as, without limitation, a web browser to access and view content over the network 110, and a File Transfer Protocol (FTP) client for file transfer. The user device 106 in various embodiments, may include a Wireless Application Protocol (WAP) browser or other wireless or mobile device protocol suites.

The network 110 generally represents one or more interconnected networks, over which the computing device 104, the pet control device 102, the user device 106 and the smart camera 108 could communicate with each other. The network 110 may include packet-based wide area networks (such as the Internet), local area networks (LAN), private networks, wireless networks, satellite networks, cellular networks, paging networks, and the like. A person skilled in the art will recognize that the network 110 may also be a combination of more than one type of network. For example, the network 110 may be a combination of a LAN and the Internet. In addition, the network 110 may be implemented as a wired network or a wireless network or a combination thereof.

The system further comprises at least one database in communication with the computing device 104. In an example, the database resides in the computing device 104. In another example, the database resides separately from the computing device 104. Regardless of the location, the database comprises a memory to store and organize data for use by the computing device 104. The database comprises information related to the user and the pet for use by the computing device 104.

In one embodiment, the computing device 104 is at least one of a server, a general-purpose computer, a special-purpose computer, a workstation, a desktop, a laptop, a tablet, a mobile phone, a mainframe, a supercomputer and a server farm. Although the computing device 104 is illustrated as a single device, the functions performed by the computing device 104 could be performed using any suitable number of computing devices 104. The computing device 104 comprises at least one memory configured to store a set of program modules and at least one processor. The processor is configured to execute the modules to perform one or more operations of the system.

The computing device 104 comprises a computer vision module and an artificial intelligence module. The computing device 104 is configured to enable the user to define at least one designated zone 204 using the user device 106 for monitoring the activity of the pet at the designated zone 204. The designated zone 204 refers to a predefined area or location equipped with surveillance or monitoring technology to observe and record the movements, behaviors, and activities of the pet. The computing device 104 provides an interface with at least six movable corners to define the designated zone 204. The interface allows users to define the designated zone 204 by adjusting the positions of six movable corners arranged in a hexagon shape. In one embodiment, the system comprises an augmented reality (AR) module configured to recognize shapes. The AR module enables precise selection of the designated zone 204, even in the event of smart camera 108 movements.

Each smart camera 108 is configured to cover at least one designated zone 204. Further, a plurality of smart cameras 108 could be used to cover a number of designated zones 204. The computing device 104 is further configured to enable the user to define at least one restricted action for the corresponding designated zone 204. In an example, the restricted action includes entry into one or more designated zones 204, and actions such as sitting, sleeping or defecating at one or more designated zones 204. The computing device 104 is further configured to receive visual data of the pet from the smart camera 108. The computing device 104 is further configured to detect the presence of pet in the designated zone 204 and detect performance of restricted action at the designated zone 204.

The computing device 104 is further configured to provide one or more first alerts to the pet to inhibit the pet from performing the restricted action via the pet device. The computing device 104 is further configured to provide one or more second alerts to the user regarding the restricted action being performed by the pet at the designated zone 204 via the user device 106. The computing device 104 is further configured to provide second alert on disconnection of the pet control device 102 and the smart camera 108. The computing device 104 enables the user to define a type of first alert via the user device 106. The computing device 104 further enables the user to adjust an intensity of the first alert via the user device 106. The computing device 104 enables the user to define a type of second alert via the user device 106. The computing device 104 further enables the user to adjust an intensity of the second alert via the user device 106. In one embodiment, the first alert includes at least one of audio alert, vibration alert, ultrasonic sound alert, ultrasonic vibration alert and combination thereof. In one embodiment, the second alert includes audio alert, vibration alert and combination thereof.

The computing device 104 further enables to determine a location of the pet. The computing device 104 is further configured to provide notifications regarding the pet activity. The computing device 104 is further configured to provide notifications regarding the restricted actions of the pet. The computing device 104 is further configured to provide notifications regarding a power level of the battery of the pet control device 102.

FIG. 2 exemplarily illustrates an environment 200 including the pet control device 102 and the smart camera 108 connected to the network 110, according to an embodiment of the present invention. In one embodiment, the pet control device 102 is connected to the smart camera 108 via Bluetooth. The smart camera 108 comprises a 2K camera component connected to a Printed Circuit Board (PCB), ensuring easy access to all components. This PCB is equivalent to the Orange Pi 5 with an RK3588 neural chip for enhanced functionality.

The smart camera 108 is disposed at the designated area 202 and configured to detect the presence of pet in a designated zone 204 and capture visual data of pet at the designated zone 204. The smart camera 108 is configured to send the visual data to the computing device 104. The computing device 104 detects the presence of pet in the designated zone 204 and detect performance of restricted action at the designated zone 204. If the pet performs the restricted actions, the computing device 104 sends the first alert and the second alert to the pet and the user, respectively.

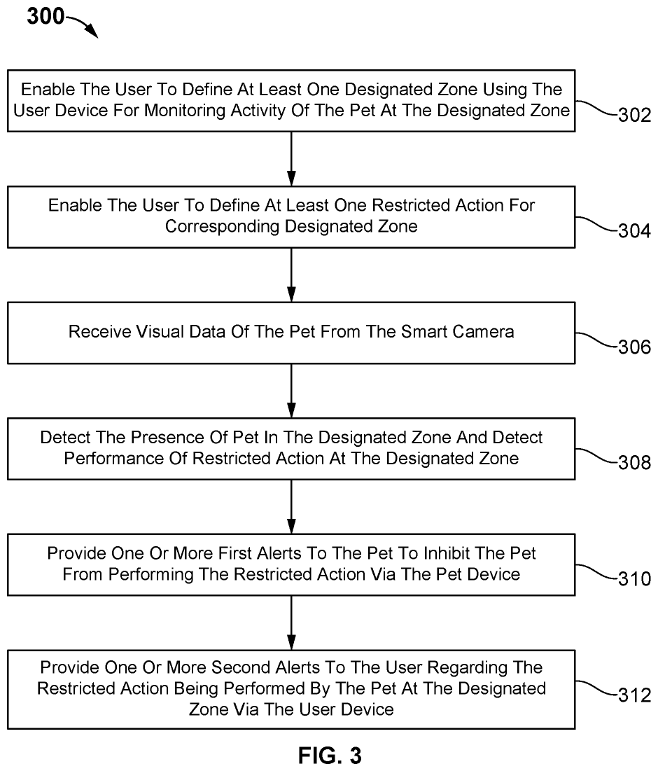

FIG. 3 exemplarily illustrates a flowchart of a method 300 for monitoring and controlling pet activity, according to an embodiment of the present invention. The method 300 is executed in the system comprising the computing device 104, the pet control device 102, the user device 106 and one or more smart cameras 108 incorporated with the computing device 104. The computing device 104 is in communication with the pet control device 102, the user device 106 and the smart camera 108. In one embodiment, the computing device 104 is in communication with the pet control device 102, the user device 106 and the smart camera 108 via the network 110.

At step 302, the computing device 104 is configured to enable the user to define at least one designated zone 204 using the user device 106 for monitoring the activity of the pet at the designated zone 204. The computing device 104 provides an interface with at least six movable corners to define the designated zone 204. The user could customize the designated zone 204 by adjusting the movable corners of the area being selected.

At step 304, the computing device 104 is further configured to enable the user to define at least one restricted action for the corresponding designated zone204. In an example, the restricted action includes entry into one or more designated zones 204, and actions such as sitting, sleeping or defecating at one or more designated zones 204.

At step 306, the computing device 104 is further configured to receive visual data of the pet from the smart camera 108.

At step 308, the computing device 104 is further configured to detect the presence of pet in the designated zone 204 and detect performance of restricted action at the designated zone 204.

At step 310, the computing device 104 is further configured to provide one or more first alerts to the pet to inhibit the pet from performing the restricted action via the pet device.

At step 312, the computing device 104 is further configured to provide one or more second alerts to the user regarding the restricted action being performed by the pet at the designated zone 204 via the user device 106. The computing device 104 enables the user to adjust an intensity of the first alert and the second alert via the user device 106. The computing device 104 enables the user to define a type of first alert and second alert via the user device106. The computing device 104 is configured to provide notifications regarding the restricted actions of the pet and a power level of the pet control device 102 via the user device 106.

Advantageously, the system integrates artificial intelligence to detect the presence of pet at the designated zones 204, detect performance of restricted actions by pets within the designated zone 204 and provides alerts to prevent the pets from engaging in these restricted actions. Further, the accuracy of the system is around 98%. The system uses real-life customer feeds and data for continuous enhancement of accuracy. The system could be used in both indoor environment and outdoor environment. The solar panel module of the smart camera 108 ensures continuous power supply to the smart camera 108 disposed at outdoor environment. This eliminates the need for frequent battery replacements and enables sustained operation even in remote locations.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. An artificial intelligence based system for monitoring and controlling pet activity, comprising:
a pet control device associated with the pet;
a user device associated with a user;
at least one smart camera disposed at one or more designated areas incorporated with a computing device, wherein the smart camera is configured to detect the presence of pet in a designated zone and capture visual data of pet at the designated zone, and
the computing device in communication with the user device, the smart camera and the pet control device via a network, wherein the computing device of the smart camera comprises computer vision module and artificial intelligence module, wherein the computing device is configured to:
enable the user to define at least one designated zone using the user device for monitoring the activity of the pet at the designated zone;
enable the user to define at least one restricted action for the corresponding designated zone;
receive visual data of the pet from the smart camera;
detect the presence of pet in the designated zone and detect performance of restricted action at the designated zone;
provide one or more first alerts to the pet to inhibit the pet from performing the restricted action via the pet device, and
provide one or more second alerts to the user regarding the restricted action being performed by the pet at the designated zone via the user device.

2. The artificial intelligence based system of claim 1, wherein the restricted action includes entry into one or more designated zones, sitting at one or more designated zones, sleeping at one or more designated zones and defecating at one or more designated zones.

3. The artificial intelligence based system of claim 1, wherein the pet control device comprises at least one of an audio sensor and a video sensor.

4. The artificial intelligence based system of claim 1, wherein the first alert includes an audio alert and vibration alert.

5. The artificial intelligence based system of claim 1, wherein the first alert includes ultrasonic sound and vibration alert.

6. The artificial intelligence based system of claim 1, wherein the pet control device comprises a control module and a communication module in communication with the control module, wherein the pet control device is configured to wirelessly communicate with the smart camera and the computing device via the communication module.

7. The artificial intelligence based system of claim 1, wherein the pet control device further comprises a power source module to supply power to the pet control device, wherein the power source module comprises a battery, a solar panel module and a power interface to directly connect to an external power source.

8. The artificial intelligence based system of claim 1, wherein the smart camera comprises a power source to supply power to the smart camera, wherein the power source comprises a battery, a solar panel module and a power interface to directly connect to an external power source.

9. The artificial intelligence based system of claim 1, wherein the computing device provides an interface with at least six movable corners to define the designated zone.

10. The artificial intelligence based system of claim 1, wherein the computing device enables the user to adjust an intensity of the first alert and the second alert via the user device.

11. The artificial intelligence based system of claim 1, wherein the computing device enables the user to define a type of first alert and second alert via the user device.

12. The artificial intelligence based system of claim 1, wherein the computing device is configured to provide the second alert on disconnection of the pet control device and the smart camera.

13. The artificial intelligence based system of claim 1, wherein the computing device is configured to provide notifications regarding the restricted actions of the pet and a power level of the pet control device via the user device.

14. The artificial intelligence based system of claim 1, wherein the pet control device is configured as a collar.

15. The artificial intelligence based system of claim 1, wherein the pet control device is configured as an anklet.

16. The artificial intelligence based system of claim 1, wherein the pet comprises a dog and a cat.
